(19) United States
(12) Patent Application Publication
(10) Pub. No.: US 2006/0068709 A1
(43) Pub. Date: Mar. 30, 2006

(54) Adaptive set partitioning for reduced state equalization and joint demodulation

(76) Inventor: Abdulrauf Hafeez, Cary, NC (US)

Correspondence Address: ERICSSON INC., 6300 LEGACY DRIVE, M/S EVR C11, PLANO, TX, 75024, US

(21) Appl. No.: 10/953,261

(22) Filed: Sep. 29, 2004

(51) Int. Cl. H04Q 7/20

(52) U.S. Cl. 455/63.1

(57) ABSTRACT

A method and a receiver (mobile station) are described herein for mitigating interference in a radio signal received from a base station and interfered for example by at least one co-channel base station, at least one adjacent channel base station and/or additive white Gaussian noise. The receiver mitigates the interference by using an enhanced reduced-state sequence estimation (RSSE) technique that selects a best set partition which is used to partition a joint signal set that is a function of symbols and channel coefficients associated with the radio signal. The best set partition is selected by exploiting estimated channel responses and/or other channel parameters like rotation and frequency offsets. And, the best set partition describes which signal states of the joint signal set are to be combined together for reduced-state joint demodulation of the radio signal or reduced-state equalization of a multiple-input-multiple-output (MIMO) channel.

### BACKGROUND OF THE INVENTION

1. Field of the Invention

The present invention relates in general to the wireless telecommunications field and, in particular, to a method and receiver (mobile station) capable of mitigating interference in a received radio signal by using an enhanced reduced-state sequence estimation (RSSE) technique.

2. Description of Related Art

Manufacturers of receivers that can be used for example in mobile stations/mobile phones are constantly trying to enhance them so they can more effectively mitigate interference in radio signals that are received from one or more base stations. One way to enhance the receivers so they can effectively mitigate the interference in received radio signals is the subject of the present invention.

### BRIEF DESCRIPTION OF THE INVENTION

The present invention includes a method and a receiver (mobile station) for mitigating interference in a radio signal received from a base station and interfered for example by at least one co-channel base station, at least one adjacent channel base station and/or additive white Gaussian noise. The receiver mitigates the interference by using an enhanced reduced-state sequence estimation (RSSE) technique that selects a best set partition which is used to partition a joint signal set that is a function of symbols and channel coefficients associated with the radio signal. The best set partition is selected by exploiting estimated channel responses and/or other channel parameters like rotation and frequency offsets. And, the best set partition describes which signal states of the joint signal set are to be combined together for reduced-state joint demodulation of the radio signal or reduced-state equalization of a multiple-input-multiple-output (MIMO) channel.

### BRIEF DESCRIPTION OF THE DRAWINGS

A more complete understanding of the present invention may be had by reference to the following detailed description when taken in conjunction with the accompanying drawings wherein:

FIG. 1 is a block diagram of a wireless communication system that includes a receiver (mobile terminal) configured in accordance with the present invention;

FIG. 2 is a diagram illustrating an Ungerboeck partition for an 8-PSK signal set;

FIG. 3 is a block diagram illustrating in greater detail the components of a preferred embodiment of the receiver shown in FIG. 1 used for reduced-state joint demodulation of multiple users (base stations) in accordance with the present invention;

FIG. 4 is a flowchart illustrating the steps of the preferred method for determining a best set partition implemented in a set partition selector of the receiver shown in FIG. 3 in accordance with the present invention;

FIG. 5 is a graph that illustrates a 2×8 RSSE partition for two 8-PSK modulated users with channel tap estimates ĉ₁(0)=1 and ĉ₂(0)=0.2e^{jπ/2};

FIG. 6 is a graph that illustrates an 8×2 RSSE partition for two 8-PSK modulated users with channel tap estimates ĉ₁(0)=1 and ĉ₂(0)=0.2e^{jπ/2};

FIG. 7 is a graph that illustrates a 4×4 RSSE partition for two 8-PSK modulated users with channel tap estimates ĉ₁(0)=1 and ĉ₂(0)=0.2e^{jπ/2};

FIG. 8 is a graph that illustrates a 2×8 RSSE partition for two 8-PSK modulated users with channel tap estimates ĉ₁(0)=1, ĉ₂(0)=1.2e^{jπ/2};

FIG. 9 is a graph that illustrates a 8×2 RSSE partition for two 8-PSK modulated users with channel tap estimates ĉ₁(0)=1, ĉ₂(0)=1.2e^{jπ/2};

FIG. 10 is a graph that illustrates a 4×4 RSSE partition for two 8-PSK modulated users with channel tap estimates ĉ₁(0)=1, ĉ₂(0)=1.2e^{jπ/2}; and

FIG. 11 is a graph that illustrates (a) 2×1 partition, (b) 1×2 partition, and (c) a joint 2-state partition for BPSK modulated users for ĉ₁(0)=1, ĉ₂(0)=0.2e^{jπ/2}.

### DETAILED DESCRIPTION OF THE DRAWINGS

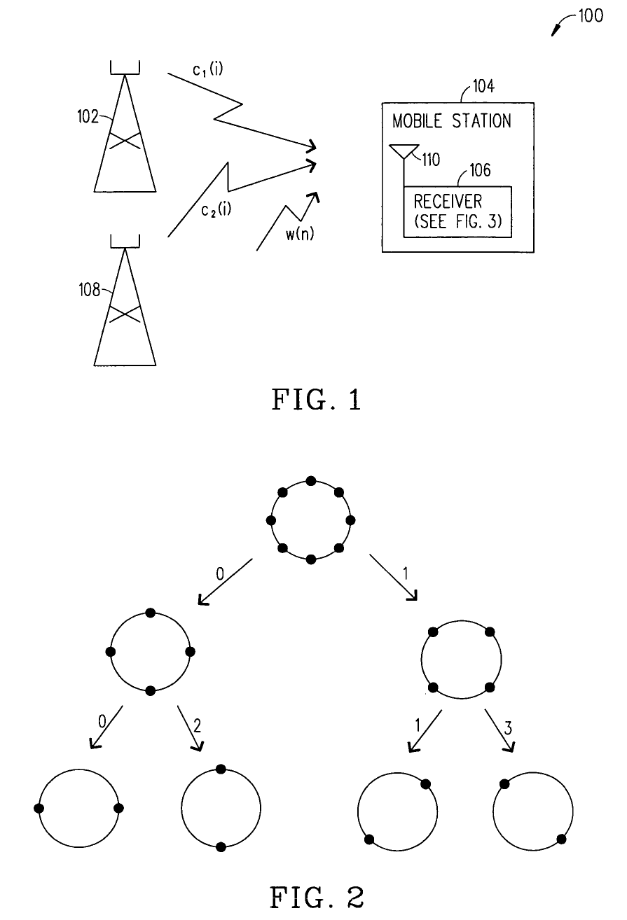

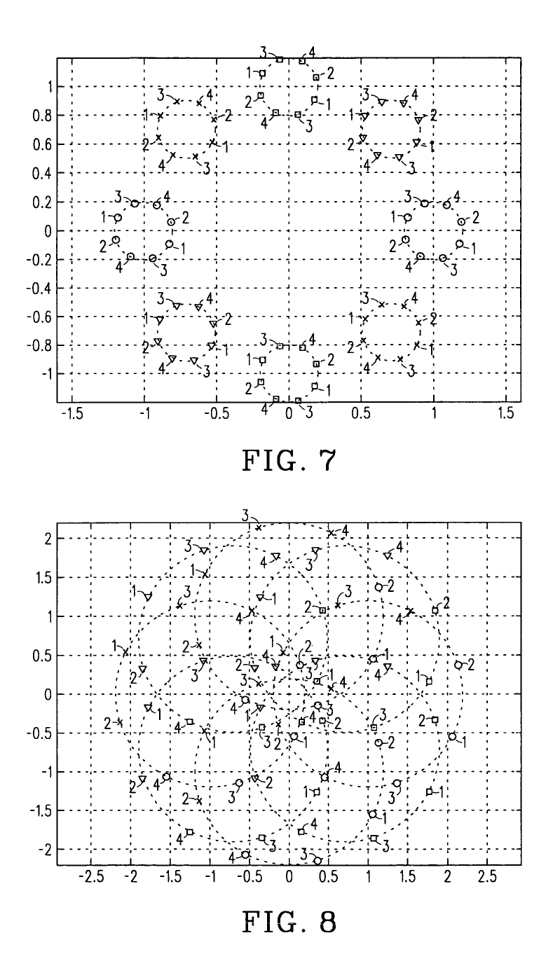

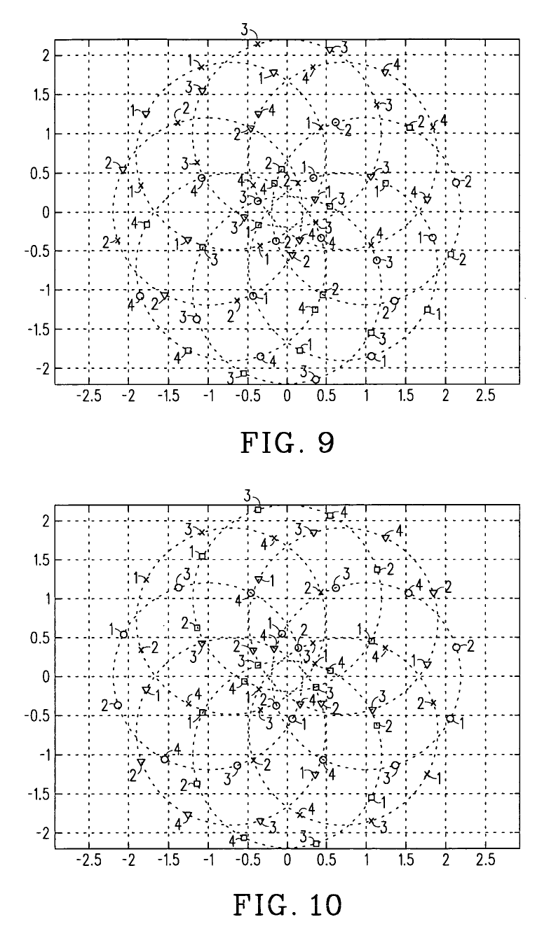

Referring to FIGS. 1-12, there is shown a receiver 106 that mitigates interference in a received radio signal by using an enhanced reduced-state sequence estimation (RSSE) technique in accordance with the present invention. It is well known that interference mitigation at a receiver (mobile station) is a major issue in wireless communication systems. In the past, receivers often implemented a maximum likelihood sequence estimation (MLSE) technique to enable equalization of inter-symbol interference and mitigation of multiuser interference through joint demodulation of multiple users (base stations). For a detailed discussion about the MLSE technique reference is made to an article written by G. D. Forney that is entitled “Maximum-likelihood sequence estimation of digital sequences in presence if ISI,” IEEE Trans. On Inf. Theory., vol. IT-18, pp. 363-378, May 1972. The contents of this article are incorporated by reference herein.

Reduced-state sequence estimation (RSSE) is a highly effective reduced-complexity alternative to MLSE. It is well known that in RSSE, the number of states is reduced by partitioning each element in a state vector into a given number of subsets and representing the subset state vector as a reduced-state trellis. The partitioning of the signal set is done on the basis of Ungerboeck's set partitioning principles that are designed to optimize performance. For a detailed discussion about the RSSE technique and Ungerboeck's set partitioning principles reference is made to the following articles: (1) M. V. Eyuboglu and S. U. H. Quereshi, “Reduced-state sequence estimation with set partitioning and decision feedback,” IEEE Trans. Commun., vol. 36, pp. 13-20, January, 1998; (2) A. Duel-Hallen and C. Heegard, “Delayed decision-feedback sequence estimation,” IEEE Trans. Commun., vol. COM-37, pp. 428-436, May 1989; and (3) G. Ungerboeck “Channel coding with multilevel/phase signals,” vol. IT-28, pp. 55-67, January 1982. The contents of these articles are incorporated by reference herein.

RSSE has been considered for joint demodulation of multiple users. In addition, RSSE has been considered for equalization of multiple-input-multiple-output (MIMO) channels. In these cases, the over-all or joint signal set, which is to be partitioned, is a function of not only the symbols but also the channel coefficients. Thus, optimum set partitioning needs to take into consideration the channel coefficients which may vary over time or from burst to burst due to fading and frequency hopping. The present invention provides a method for enabling an enhanced RSSE with set partitioning which is done in consideration of the channel coefficients and other modulation parameters like rotation and frequency offsets.

To help describe the present invention, consider a wireless communication system 100 as shown in FIG. 1. A signal c₁(i) transmitted from a base station 102 (desired user 102) to a single-antenna receiver 106 (shown) or a multi-antenna receiver (not shown) in a mobile station 104. The signal is received by the receiver 106 in the presence of interference arising from signals c₂(i) transmitted from co-channel base stations 108 (only one nondesired user 108 is shown) and additive white Gaussian noise w(n). The desired base station 102 and interfering co-channel base station 108 (only one shown) may employ different modulation schemes (GMSK or 8-PSK) to transmit information. The radio signal, received by a single antenna 110 at the mobile station 104, is converted into baseband and filtered. The filtered signal is sampled at the symbol rate and de-rotated to undo the modulation rotation of the desired base station 102. The sampled received signal r(n) from two users 102 and 108 is given by:

$$r ( n ) = {\sum }_{i = 0}^{L} {c}_{1} ( i ) {s}_{1} ( n - i ) + {\sum }_{i = 0}^{L} {c}_{2} ( i ) {s}_{2} ( n - i ) + w ( n ) \qquad ( 1 )$$

where sₖ(n) and cₖ(i) are the transmitted symbols (which take values in the set Aₖ of cardinality Mₖ) and channel coefficients (spanning L+1 symbols) for user k, respectively (user 1 being the desired user), and w(n) is a sample of a white Gaussian noise process. Let

$${p}_{n} = [ \begin{matrix}{s}_{1} ( n - 1 ) , & {s}_{1} ( n - 2 ) , & … & {s}_{1} ( n - L ) \\ {s}_{2} ( n - 1 ) , & {s}_{2} ( n - 2 ) , & … & s ( n - L )\end{matrix} ] \qquad ( 2 )$$

represent the state of the joint trellis for MLSE. The number of states in the joint trellis is (M₁M₂)^{L}. Using RSSE, the number of states in the joint trellis can be reduced to

$${\prod }_{l = 1}^{L} {J}_{1} ( l ) {J}_{2} ( l ) ,$$

where Jₖ(l)≦Mₖ,∀l,k. This is done by partitioning the set of signal points corresponding to the symbol sₖ(n−l) into Jₖ(l) subsets (of size M/Jₖ(l)) as defined by the partition Ωₖ(l) for l=1, 2, . . . L. To define a proper trellis, set partitioning is done such that each partition Ωₖ(l) is a further partition of the subsets of the partition Ωₖ(l+1), i.e. Jₖ(l)≧Jₖ(l+1), ∀l. The subset state (or reduced state) tₙ is defined as the sequence of subsets of the L most recent symbols for both users 102 and 108 in the respective partitions, i.e.

$${t}_{n} = [ \begin{matrix}{a}_{1} ( n - 1 ) , & {a}_{1} ( n - 2 ) , & … & {a}_{1} ( n - L ) \\ {a}_{2} ( n - 1 ) , & {a}_{2} ( n - 2 ) , & … & {a}_{2} ( n - L )\end{matrix} ] \qquad ( 3 )$$

where aₖ(n−l) is the index of the subset of the partition Ωₖ(l) to which the symbol sₖ(n−l) belongs. The index aₖ(n−l) can take values in the set of integers between 1 and Jₖ(l) The current state tₙ is uniquely identified by the previous state tₙ₋₁ and the subsets a₁(n) and a₂(n) of the current symbols. There are M₁×M₂ branches emanating from each state corresponding to the M₁×M₂ possible values of the symbol vector [s₁(n),s₂(n)]^{T}. However, there are only J₁(1)×J₂(1) next states for each current state corresponding to the values of the subset index vector [a₁(n),a₂(n)]^{T}. Thus, two branches or paths originating from the same state at time n end up on the same state at time n+1 if their current symbol hypotheses belong to the same subset index vector. These paths are called parallel paths.

In the joint RSSE scheme described above, the partition is defined independently for each user 102 and 108. In this case, set partitioning may be done as in single-user RSSE (see article by M. V. Eyuboglu), where the subsets are chosen such that the minimum intra-subset Euclidean distance is maximized. Ungerboeck showed that this can be achieved by successive two-way partitions of the signal space as shown in FIG. 2 for 8-PSK signal set. For the joint RSSE scheme described above, Ungerboeck's set partitioning principles can be applied independently for the two users 102 and 108. In the following, we consider joint RSSE partitions denoted as J₁(1)×J₂(1) (for L∂1) where the signal set for the first user is partitioned into J₁(1) subsets and the signal set for the second user is partitioned into J₂(1) subsets. In general, multiple set partitions can be found with the same number of states. For example, for L∂1 and M₁=M₂=8, the partitions: J₁(1)×J₂(1)∂8×2, 4×4, and 2×8 have 16 states each. Finding the best RSSE configuration or partition is the subject matter of the present invention which is described in detail next.

The present invention includes a method for finding the best set partition for reduced state equalization or joint demodulation by exploiting the estimated channel responses and/or other channel parameters. The set partition describes which signal states are to be combined together for reduced-state joint demodulation of multiple users 102 and 108 or reduced-state equalization of a MIMO channel. In the present invention, a different set partition may be used for demodulation of each burst (or slot) of data.

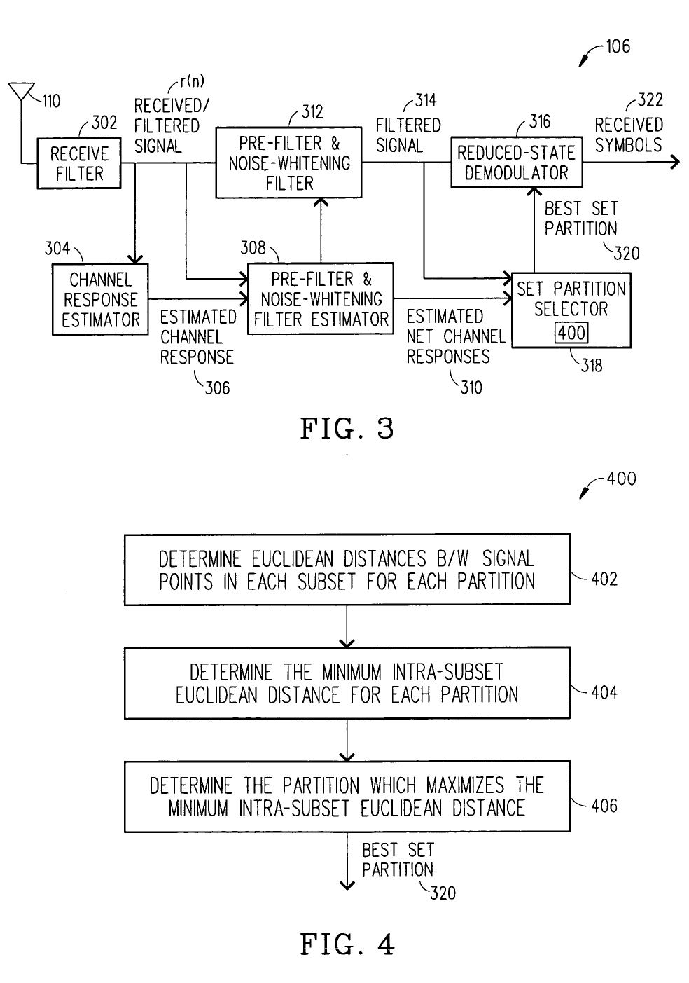

Referring to FIG. 3, there is shown a block diagram of a preferred embodiment of the receiver 106 used for joint demodulation of two users 102 and 108 in accordance with the present invention. As shown, the radio signal is received by the antenna 110 and filtered and possibly over-sampled by a front-end receive filter 302. A channel response estimator 304 estimates the channel responses 306 of the two users 102 and 108 by using their training symbols. A pre-filter and noise-whitening filter estimator 308 estimates the net channel responses 310 based on the estimated channel responses 306 and the received signal r(n). The received signal r(n) is passed through the pre-filter and noise-whitening filter 312 which uses the estimated net channel responses 310 before being fed as a filtered signal 314 to a joint demodulator/reduced-state demodulator 316. A set partition selector 318 which receives the filtered signal 314 then selects the best partition 320 from a set of given partitions by exploiting the estimated net channel responses 310 for the two users 102 and 108 obtained from the channel and pre-filter estimators 304 and 308. The reduced-state demodulator 316 uses the reduced-state joint trellis determined by the selected set partition 320 to jointly demodulate the data symbols in the filtered signal 314 received from two users 102 and 108 and then output received symbols 322.

The set partition selector 318 finds the partition which maximizes the minimum Euclidean distance between parallel paths in the joint trellis. Since parallel paths in the joint trellis differ in the current symbols of the users 102 and 108, set partitioning is done for the current symbol time. The signal set for the current symbol time is given by all possible values of {ĉ₁(0)s₁+ĉ₂(0)s₂}, where sₖεAₖ are the symbol hypotheses and ĉₖ(0) is the first tap of the estimated net channel response 306 for users k. The Euclidean distance between signal points s₁^{a},s₂^{a} and s₁^{b},s₂^{b} is given by |ĉ₁(0)s₁^{a}+ĉ₂(0)s₂^{a}−ĉ₁(0)s₁^{b}−ĉ₂(0)s₂^{b}|². One embodiment of the method 400 used by the set partition selector 318 to select the best set partition 320 is shown in FIG. 4. As shown, the set partition selector 318 finds the partition 320 that maximizes the minimum intra-subset Euclidean distance by (1) determining Euclidean distances between signal points in each subset for each partition (step 402); (2) determining a minimum intra-subset Euclidean distance for each partition (step 404); and (3) determining the best set partition 320 which is the one that maximizes the minimum intra-subset Euclidean distance (step 406).

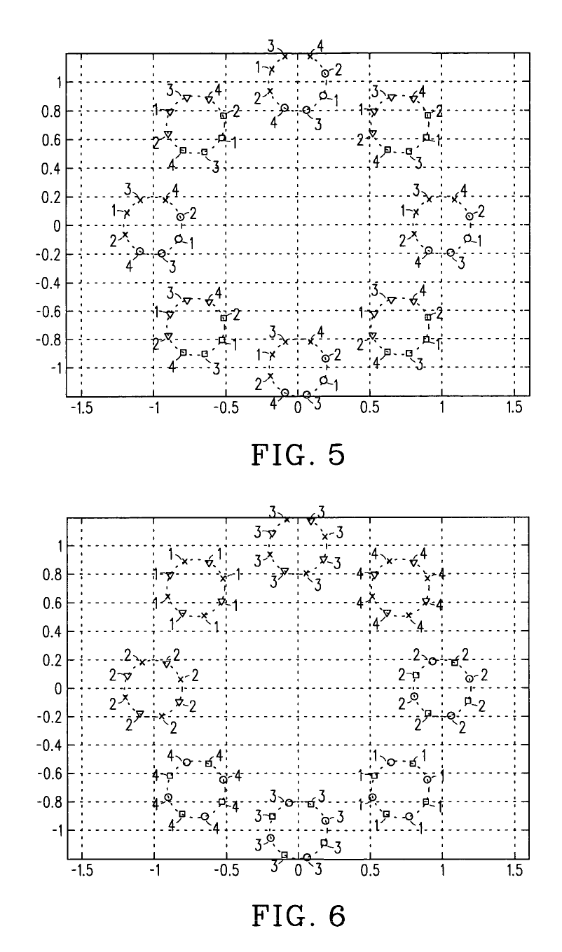

To illustrate the operation of the set partition selector 318, consider the graphs shown in FIGS. 5-10 which illustrate several examples of joint demodulation of two users 102 and 108 with 8-PSK modulation and channel memory L∂1 and a joint RSSE with 16 states. In these graphs, it should be noted that a joint RSSE partition where the signal set for the first user is partitioned into J₁(1) subsets and the signal set for the second user is partitioned into J₂(1) subsets is denoted as J₁(1)×J₂(1). Also, in these graphs, the signal points that belong to the same subset are marked with the same legend (and the same reference number 1, 2, 3 or 4). In particular, FIGS. 5-7 are graphs that show various 16-state partitions for ĉ₁(0)=1 and ĉ₂(0)=0.2e^{jπ/10}. With respect to these graphs, it can be observed that the 2×8 partition maximizes the minimum intra-subset Euclidean distance. FIGS. 8-10 show the partitions for ĉ₁(0)=1 and ĉ₂(0)=1.2e^{jπ/10}. With respect to these graphs, the 8×2 partition maximizes the Euclidean distance. It turns out that for a 16-state joint RSSE, the 2×8 partition maximizes the minimum intra-subset Euclidean distance if |ĉ₁(0)|>|ĉ₂(0)| and the 8×2 partition maximizes the distance if |ĉ₁(0)|<|ĉ₂(0)|. For an 8-state joint RSSE, the partitions 8×1, 2×4, 4×2,and 1×8 need all be considered to maximize the distance under various channel conditions. As in the 16-state case, it may be possible to derive simple tests based on the channel tap strengths to determine the best set partition 320. In this case, it will not be necessary to find the Euclidean distances between the signal points of a subset for all subsets of all partitions to find the optimal set partition 320 as in FIG. 4.

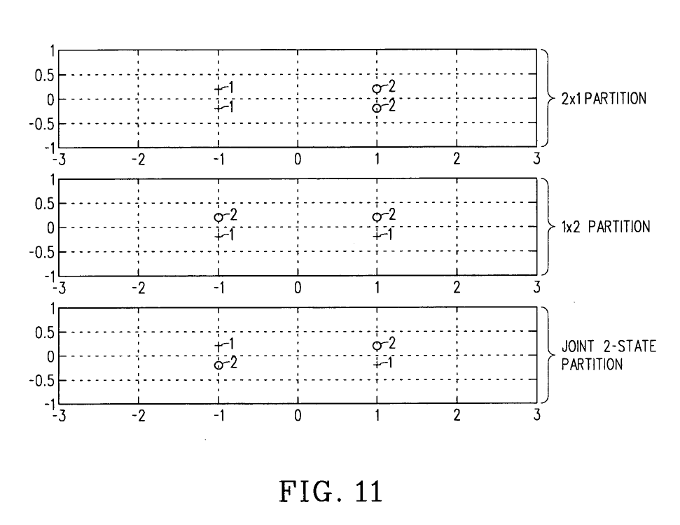

In the RSSE scheme described above, signal set partitioning is done independently for each user 102 and 108, although the best set partition 320 is chosen by considering the joint signal set. Signal set partitioning can also be done jointly for the users 102 and 108 by considering the joint signal set. However, this is more difficult for higher-order modulation as the joint signal set depends on the channel coefficients. Following is an example to illustrate the joint set partitioning. Consider two users with binary modulation and channel memory equal to one. Next consider joint demodulation using RSSE with two states. Three partitions of the joint signal set are shown in FIG. 11 for ĉ₁(0)=1 and ĉ₂(0)=0.2e^{jπ/2}. The first two partitions are independent partitions 2×1 and 1×2, while the third partition is a joint partition. It can be seen that the joint partition maximizes the minimum intra-subset Euclidian distance and is thus the best partition for the given channel taps.

A detailed description of the reduced-state joint demodulation of two users 102 and 108 has been provided above with respect to FIGS. 1-12. It should be appreciated that the use of the present invention for reduced-state MIMO channel equalization is simply a generalization of the joint demodulation embodiment.

Moreover, in the preferred embodiment of the present invention described above, it should be appreciated that the signal was interfered by at least one co-channel base station and additive white Gaussian noise. However, it should be noted that the interfering co-channel base station may not be an interferer because MIMO channel equalization using RSSE does not employ joint demodulation of two users. In addition, it should be noted that an adjacent channel base station nay be an interferer because joint demodulation can be performed for an adjacent channel interferer.

Furthermore, it should be appreciated that many components and details associated with the receiver 106 described above are well known in the industry. Therefore, for clarity, the description with respect to the receiver 106 omitted those well known components and details that are not necessary to understand the present invention.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A mobile station comprising a receiver capable of mitigating interference in a radio signal received from a base station by using a reduced-state sequence estimation (RSSE) technique that selects a set partition which is used to partition a joint signal set that is a function of symbols and channel coefficients associated with the radio signal.

2. The mobile station of claim 1, wherein said radio signal is interfered by at least one co-channel base station and additive white Gaussian noise.

3. The mobile station of claim 1, wherein said radio signal is interfered by at least one adjacent channel base station and additive white Gaussian noise.

4. The mobile station of claim 1, wherein said set partition is selected by exploiting estimated channel responses and/or channel parameters.

5. The mobile station of claim 1, wherein said selected set partition describes which signal states of the joint signal set are to be combined together for reduced-state equalization of a multiple-input-multiple-output (MIMO) channel.

6. The mobile station of claim 1, wherein said selected set partition describes which signal states of the joint signal set are to be combined together for reduced-state joint demodulation of the radio signal.

7. The mobile station of claim 1, wherein a different set partition is selected for each burst of data in the radio signal.

8. The mobile station of claim 1, wherein said receiver is a single-antenna receiver.

9. The mobile station of claim 1, wherein said receiver is a multi-antenna receiver.

10. A receiver comprising:
a receive antenna and receive filter for receiving and filtering a radio signal;
a channel response estimator for estimating channel responses using training symbols in the received radio signal;
a pre-filter and noise-whitening filter estimator for estimating net channel responses using the estimated channel responses and the received radio signal;
a pre-filter and noise-whitening filter for filtering the received radio signal using the estimated net channel responses;
a set partition selector for selecting a best set partition from a group of given partitions by using the estimated net channel responses and the filtered radio signal; and
a reduced-state demodulator for jointly demodulating data symbols in the filtered radio signal using a reduced-state joint trellis determined by the selected best set partition.

11. The receiver of claim 10, wherein said set partition selector selects the best set partition by:
determining Euclidean distances between signal points in each subset for each partition;
determining a minimum intra-subset Euclidean distance for each partition; and
determining the best set partition which is the one that maximizes the minimum intra-subset Euclidean distance.

12. The receiver of claim 10, wherein said selected best set partition describes which signal states of a joint signal set associated with the filtered radio signal are to be combined together for reduced-state equalization of a multiple-input-multiple-output (MIMO) channel.

13. The receiver of claim 10, wherein said selected best set partition describes which signal states of a joint signal set associated with the filtered radio signal are to be combined together for reduced-state joint demodulation of the filtered radio signal.

14. The receiver of claim 10, wherein said set partition selector selects a different best set partition for each burst of data in the filtered radio signal.

15. The receiver of claim 10, wherein said receive filter over-samples the radio signal.

16. A method for mitigating interference at a receiver in a wireless communication system, said method comprising the steps of:
receiving and filtering a radio signal;
estimating channel responses using training symbols in the received radio signal;
estimating net channel responses using the estimated channel responses and the received radio signal;
filtering the received radio signal using the estimated net channel responses;
selecting a best set partition from a group of given partitions by using the estimated net channel responses and the filtered radio signal; and
jointly demodulating data symbols in the filtered radio signal using a reduced-state joint trellis determined by the selected best set partition.

17. The method of claim 16, wherein said set partition selector selects the best set partition by:
determining Euclidean distances between signal points in each subset for each partition;
determining a minimum intra-subset Euclidean distance for each partition; and
determining the best set partition which is the one that maximizes the minimum intra-subset Euclidean distance.

18. The method of claim 16, wherein said selected best set partition describes which signal states of a joint signal set associated with the filtered radio signal are to be combined together for reduced-state equalization of a multiple-input-multiple-output (MIMO) channel.

19. The method of claim 16, wherein said selected best set partition describes which signal states of a joint signal set associated with the filtered radio signal are to be combined together for reduced-state joint demodulation of the filtered radio signal.

20. The method of claim 16, wherein a different best set partition is selected for each burst of data in the filtered radio signal.

21. A wireless communication system comprising:
a receiving unit;
a transmitting unit; and
said receiving unit for mitigating interference in a radio signal received from said transmitting unit by using a reduced-state sequence estimation (RSSE) technique that selects a best set partition which is used to partition a joint signal set that is a function of symbols and channel coefficients associated with the radio signal.

22. The wireless communication system of claim 21, wherein said radio signal is interfered by at least one co-channel base station and additive white Gaussian noise.

23. The wireless communication system of claim 21, wherein said radio signal is interfered by at least one adjacent channel base station and additive white Gaussian noise.

24. The wireless communications system of claim 21, wherein said receiving unit further includes:
a receive antenna and receive filter for receiving the radio signal;
a channel response estimator for estimating channel responses of the transmitting unit and at least one co-channel transmitting unit using training symbols in the received radio signal;
a pre-filter and noise-whitening filter estimator for estimating net channel responses using the estimated channel responses and the received radio signal;
a pre-filter and noise-whitening filter for filtering the received radio signal using the estimated net channel responses;
a set partition selector for selecting the best set partition from a group of given partitions by using the estimated net channel responses and the filtered radio signal; and
a reduced-state demodulator for jointly demodulating data symbols in the filtered radio signal using a reduced-state joint trellis determined by the selected best set partition.

25. The wireless communications system of claim 24, wherein said set partition selector selects the best set partition by:
determining Euclidean distances between signal points in each subset for each partition;
determining a minimum intra-subset Euclidean distance for each partition; and
determining the best set partition which is the one that maximizes the minimum intra-subset Euclidean distance.

26. The wireless communication system of claim 24, wherein said receive filter over-samples the radio signal.

27. The wireless communications system of claim 21, wherein said receiving unit is a mobile station.

28. The wireless communications system of claim 21, wherein said transmitting unit is a base station.

29. The wireless communications system of claim 21, wherein said receiving unit is a single antenna receiving unit or a multi-antenna receiving unit.
